(19) United States
(12) Patent Application Publication
(10) Pub. No.: US 2026/0281906 A1
(43) Pub. Date: Sep. 17, 2026

(54) NETWORK CONNECTIVITY BASED ON BATTERY CHARGE LEVEL IN A TELECOMMUNICATIONS NETWORK

(71) Applicant: T-Mobile USA, Inc., Bellevue, WA (US)

(72) Inventor: Relin Thomas, Bellevue, WA (US)

(21) Appl. No.: 19/076,851

(22) Filed: Mar. 11, 2025

(51) Int. Cl. H04W 52/02

(52) U.S. Cl. CPC H04W 52/0261; H04W 52/0212

(57) ABSTRACT

Techniques for managing user equipment (UE) access to a network element based on battery information are described herein. A telecommunications system can implement a computing device to detect a charge level of a battery coupled to the UE and to configure a communication channel for the UE based on the battery information. The computing device can determine a setting(s) (e.g., power control, tilt angle, a number of carriers and/or layers, etc.) that improves network efficiency of a network element. The computing device can also or instead compare the battery information to metadata associated with respective communication channels, and select a communication channel based on the comparison. The setting(s) of the network element and/or the communication channel can cause the UE to reduce battery consumption over time.

### BACKGROUND

Modern terrestrial telecommunication systems include heterogeneous mixtures of second, third, fourth, and/or fifth generation (2G, 3G, 4G, and/or 5G) cellular-wireless access technologies, which can be cross-compatible and can operate collectively to provide data communication services. Global Systems for Mobile (GSM) is an example of 2G telecommunications technologies; Universal Mobile Telecommunications System (UMTS) is an example of 3G telecommunications technologies; and Long Term Evolution (LTE), including LTE Advanced, and Evolved High-Speed Packet Access (HSPA+) are examples of 4G telecommunications technologies. 5G NR, including 5G non-standalone (NSA) and 5G standalone (SA), are examples of 5G telecommunications technologies. 5G provides improved bandwidth and decreased response times to a multitude of devices that may be connected to a network in comparison to previous generations of telecommunication technologies.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 depicts an example network environment in which an example device can connect to a telecommunications system that includes an example access management system to implement the techniques described herein.

FIG. 2 depicts an example system architecture for a fifth generation (5G) telecommunication network.

FIG. 3 depicts another example network environment in which an example user equipment can connect to a telecommunication system that includes an example access management system to implement the techniques described herein.

FIG. 4 depicts a flowchart of an example process for selecting a communication channel for a user equipment by an example access management system based on detected battery data.

FIG. 5 depicts an example system architecture for a user equipment.

### DETAILED DESCRIPTION

This application relates to techniques for determining access for a device to a telecommunications network based on battery information associated with the device. The techniques can include a system controlling access of the device to a network element (e.g., a base station, a transceiver, or the like) based on a charge level, battery capacity, charge information, discharge information, etc. of a battery coupled to the device. For example, the system can detect the battery information in a message from the device and determine a communication channel for the device based on the battery information. The system can determine device access over time by using different communication channels that are configured to use different amounts of power. The techniques can improve battery performance (e.g., optimize power available from the battery) by determining communication channels for a communication session that require different amounts of power to exchange data. The techniques allow the telecommunications network to utilize network resources for a device(s) in critical battery mode while also maintaining a balance with network capacity and spectral efficiency (e.g., lowering transmission power or number of channels), quality of service, latency, etc. (e.g., by the network element deciding on the communication channel).

In some examples, the techniques can include managing battery efficiency for the battery of the device by dynamically determining communication channel(s) for exchanging data with the device as the battery information changes. In some examples, the system can determine the level of charge (e.g., storage capacity) of the battery based on analyzing a message from the device. The message may be associated with a request from the device for a communication session or may be sent periodically to report battery information at different times or time intervals, etc.

The level of charge (also referred to herein as “charge level”) of a battery can represent a value that indicates, for example, an amount of power available to the device. The device can use some of the power stored in the battery to exchange (e.g., send and/or receive) data with a network element. In some examples, the network element can represent a base station that receives a request for a service(s) provided by a telecommunications system from a user equipment (UE) and selects a communication channel for the UE to access the network element based on detecting the charge level of the battery. An access management system can, for example, compare the charge level to a threshold and/or to a range of charge levels associated with respective communication channels, and select the communication channel meeting the threshold and/or having the range of charge values that includes the battery charge level. Using a particular communication channel that is configured for a detected charge level can cause the battery of the UE to use less power to exchange data with the network element (e.g., less transmission power, fewer processes to process, etc.).

By way of example and not limitation, the telecommunications system can include a computing device to determine a communication channel for a UE based on battery data associated with a battery of the UE. The computing device may, for example, detect, receive, access, or otherwise determine battery data representing one or more of: a charge level, discharge rate, charge rate, predicted charge level at a future time, to name a few. In various examples, at least some of the battery data may be detected in a message exchanged between the UE and a network element.

A battery may provide power to a receiving antenna, a transmitting antenna, a display, a speaker, a processor, a microphone, and/or other components of a device. Battery activity (or usage) can vary over time based on a location of the device, a number of applications or services being used, etc. The device may require more power when not connected to WiFi and/or a number or type of obstacles between the device and the network element. In some examples, the battery may increase power output by an antenna due to the device being indoors, in a tunnel, or the like. Battery activity may also or instead vary due to user interaction with the device, applications executing by the device, services used for exchanging data, and so on. Battery activity may also be predicted by a machine learned model to generate predicted battery activity. For example, services provided to the device by the telecommunications system can impact battery consumption when a first service (e.g., exchanging video data packets) requires more power from the battery to operate than a second service (e.g., exchanging text data packets). To improve battery capacity of the device battery, the system can determine a communication channel for the device based on analyzing the battery activity data and selecting the communication channel based on the battery activity data associated with a previous time (e.g., historical battery activity), battery activity data associated with a current time (e.g., current battery activity), and/or battery activity data associated with a predicted time (e.g., predicted battery activity).

The techniques described herein can reduce or eliminate instances when the device operates in “low power mode” or the battery is unable to provide power by proactively determining communication channels over time in accordance with the changing charging level of the battery. In some examples, the access management system can determine a communication channel (from a set of available communication channels) for exchanging data that uses less power of the battery relative to using another communication channel that is configured to use more power from the battery to exchange different types or amounts of data.

In examples when the charge level of the battery is below a charge threshold, the access management system can select and initiate use of a communication channel that limits discharge of the battery. In examples when the charge level of the battery meets or exceeds the charge threshold, another communication channel can be used by the device that is associated with more or different services or applications that require more power output by the device to operate. A communication channel may be selected by the access management system based on matching the charge level of the battery with a range of values associated with each respective communication channel. For example, each respective communication channel may be associated with metadata indicating a range of charge values usable for selecting the communication channel.

In various examples, the access management system can select, identify, or determine a communication channel that limits at least one of: a number of carriers, a number of antenna, power transmission by the network element, or the like, for the telecommunications network to exchange data with the device. For instance, the access management system can configure respective communication channels to operate using a particular a number of carriers, layers, technology type, etc. and further determine a battery charge level range for the communication channel (e.g., for use when the battery is at 60-70% capacity or some other range). Additional discussion of selecting a communication channel and/or assigning a battery charge level range or other metadata to a communication channel can be found throughout this disclosure including in the figures below.

In some examples, the access management system can determine parameters for the network element that causes a reduction in power consumption by the device thereby improving performance of the device. For example, an analysis component of a computing device can receive battery information and determine parameters for one or more network elements used to exchange data with the device. In some examples, the parameters of the network element can represent one or more of: downlink power, uplink power, number of downlink transmitters, number of uplink transmitters, numbers of concurrently connected users, cell radius, and so on.

In some examples, the telecommunications system can implement a computing device and/or an access management system to dynamically assign a communication channel to a device based on battery information of a battery of the device. The battery information can indicate, for example, a charge level associated with a previous time, a current time, and/or a future time. For instance, the device can transmit battery information that includes a current charge-level of the battery, a change in battery charge over time, or other information associated with the battery, to the computing device and/or the access management system.

The battery information may include values indicative of predicted battery charge levels from a machine learned model, depending on examples. For example, one or more machine learned models can analyze historical battery behavior including activity (or usage) data, profile data, etc. to predict charge levels for a future time period. In various examples, a communication channel may be assigned based at least in part on the predicted charge levels from the machine learned model(s).

The computing device can, in some examples, determine metadata for each respective communication channel indicating a range of battery charge levels. The computing device can assign, select, or identify one or more of the communication channels for use at a particular time by the UE based on the charge level being within the range of battery charge levels of a particular communication channel.

In various examples, the computing device and/or the access management system can implement a machine learned model to receive, as input data, profile data associated with the device indicating whether to allow battery optimization by the telecommunications network. For example, a user of the device can provide an input to a user interface indicating to “manage battery efficiency” “enable battery optimization” (or the like) in association with a telecommunications network. A user may also or instead respond to a notification sent to the device from the computing device to approve or validate that the device can send battery information to the telecommunications system to optimize battery charging and/or battery storage. However, in other examples, the techniques can be performed independent of receiving explicit input from a user of the device. The machine learned model may also or instead receive input data including historical battery information (e.g., battery charge at different times, times that the battery was charged, etc.) and/or historical device activity data (e.g., services accessed, applications accessed, etc.).

The machine learned model can output data representing a predicted charge level(s) for a battery of the device. The data output by the machine learned model can be used by the computing device and/or the access management system to configure communication channels for the device to access one or more network elements or another entity of the telecommunications system. For example, the data output by the machine learned model may be used as input data into another model or component that selects a pre-configured communication channel for the device to access the network element(s). In various examples, implementing the machine learned model enables a downstream model or component to select or determine a communication channel that causes a level of power consumption by the device. For example, the access management system can select the communication channel from a set of communication channels based on the level of power consumption.

The techniques described here can improve battery performance in a variety of ways. For example, The access management system can, for example, detect battery information in a message transmitted between the device and the network element. For example, the battery information (e.g., charge level, rate of change in charge level over a time period, etc.) may be detected in a request to initiate a call by the device or during a call between the device and another device. In some examples, the device can send the battery information at pre-determined intervals (e.g., every hour or other interval, when the charge reaches a pre-determined threshold, etc.). Additional discussion of managing device access by a component or system associated with a network element(s) can be found throughout this disclosure including in the figures below.

In some examples, the network element can represent, for example, a base station (gNB), a transceiver, an antennae, a relay point, an access point, a serving node, a computing device (e.g., a server), or other entity of the telecommunications network. The techniques described herein can be used to control which network elements are accessed by a device based on the battery information associated with the device. For instance, an access management component of a computing device can optimize settings or parameters for one or more network elements (e.g., adjust power output for one or more network elements) to improve battery activity for various time periods associated with a communication session with the device.

In various examples, the computing device can be centrally located (e.g., separate from a network element) and/or located at one or more of the network elements. Regardless of location, the computing device can optimize battery storage, settings, thresholds, and the like for various network elements to improve efficiency of available network elements to provide services to the greatest number of devices.

The access techniques described herein can improve a computing device and/or network in a variety of ways. Quality of service, network bandwidth, etc. can be improved by managing access to a device with consideration to battery information associated with the device. For instance, a UE can receive service from a network element based on the battery information indicating a charge level of the battery is within a threshold range for a particular communication channel.

The access techniques may also improve the telecommunications use of available computational resources (e.g., network elements, processing resources, memory resources, and the like) by limiting use of available processor, memory, and/or power resources. For example, to optimize battery capacity a telecommunications network can limit power output for a particular communication channel thereby saving computational resources available to the telecommunications network which causes a reduction in the amount of power required for the device to establish and maintain the communication channel with a network element.

Though some examples are described in relation to a computing device, in various examples one or more computing devices, UEs, networks, or other entities may perform or otherwise be associated with the techniques described herein. In various examples, the device may be configured with instructions to implement the techniques described herein. For example, the device can be configured with the instructions to cause the device to use a particular network element for transmitting a first message to a particular server, base station, or network (e.g., a core network).

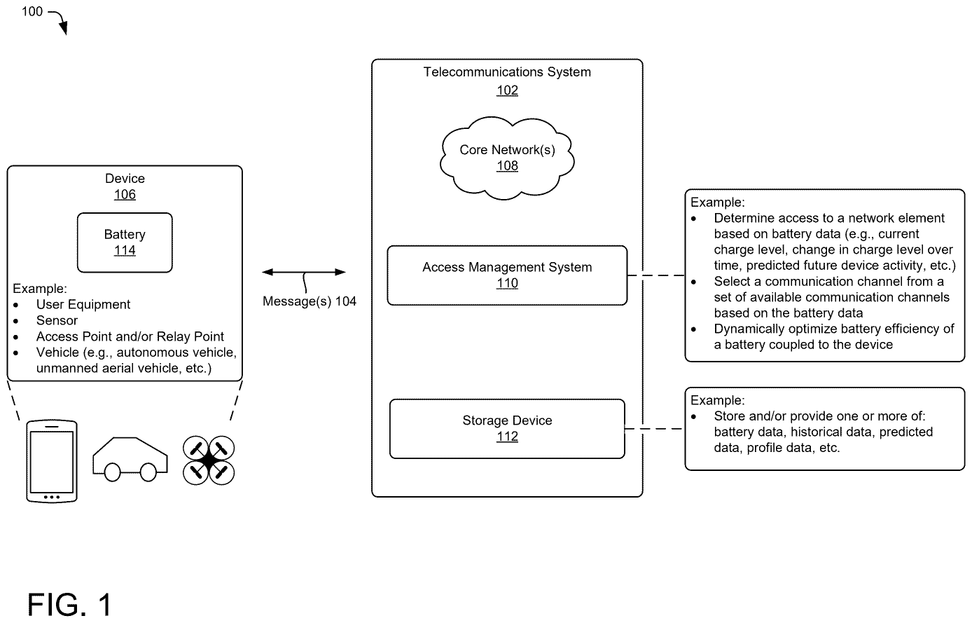

FIG. 1 depicts an example network environment 100 in which an example device can connect to a telecommunications system that includes an example access management system to implement the techniques described herein. For example, a telecommunications system 102 can exchange one or more messages 104 (may also be referred to as the message 104 or the message(s) 104) with a device 106. As shown in FIG. 1, the telecommunications system 102 includes one or more core network(s) 108 for exchanging data (may also be referred to as the core network 108 or the core network(s) 108), an access management system 110, and a storage device 112. The access management system 110 can be configured to determine a communication channel for the device 106 based on battery data associated with the device 106. In various examples, the device 106 can connect to a network element to exchange data using a communication channel selected from a set of communication channels.

The message 104 can represent a communication or an exchange of data between the device 106 and the core network 108, such as a request from the device 106 to place a call, access a service, or otherwise connect to the telecommunications system 102. The message 104 may, for example, represent a communication between the device 106 (e.g., a first UE) and a second UE. In some examples, the message 104 can include battery data associated with the device 106 such as a battery charge level (e.g., battery charge data), a time of last charge, or other battery information of a battery 114 coupled to the device 106. In some examples, the charge level can indicate a capacity of the battery 114 (e.g., 67%, or some other mathematical representation or computer-readable represent) and may be stored in the storage device 112. In various examples, the battery data is usable to control power output, frequency output, a title angle (e.g., mechanical and/or electronic), or the like of a network element to transmit the message 104, or a subsequent message. In some examples, the access management system 110 can select a communication channel from the set of communication channels for exchanging data in the message 104. For example, the access management system 110 can identify that the charge level of the battery 114 (67%) is within a range of charge levels (e.g., 65-70%) associated with the communication channel.

In some examples, the message 104 may be associated with a network-control policy such as a message associated with Radio Resource Control (RRC). For example, the network-control policy can be used to cause the device 106 (and other devices) to report battery information to the telecommunications network. However, the battery information may also or instead be sent from the device 106 based at least in part on a vendor adding the battery reporting functionality to the device 106. In some examples, the access management system 110 can send computer-readable instructions to the device 106 to cause the device 106 to send the battery information in the message 104.

The device 106 may represent any device that can wirelessly connect to the telecommunication network, and in some examples may include a mobile phone, a sensor, a personal digital assistant (PDA), a personal computer (PC) such as a laptop, desktop, or workstation, a media player, a tablet, a gaming device, an access point, a relay point, a smart watch, a hotspot, a Machine to Machine device (M2M), a vehicle (e.g., an autonomous vehicle, an unmanned aerial vehicle, airplane, boat, etc.), an Internet of Things (IoT) device, or any other type of computing or communication device.

The core network 108 can represent a 5G network in various examples, though other core network types may also be used (e.g., past or future generation networks such as a sixth generation (6G) network).

The access management system 110 may represent firmware, hardware and/or software that generates, assigns, selects, or otherwise determines a communication channel(s) for the device 106. The access management system 110 may, in some examples, provide functionality to determine access to a network element based at least in part on the information in the message 104 (e.g., the battery charge level, etc.). For example, the access management system 110 can select the communication channel to exchange data with the device 106 based on analyzing at least some of the battery data in the message 104 (e.g., compare the battery data to a threshold and/or to values associated with a communication channel, etc.). In various examples, a network element can represent a base station (gNB), a transceiver, an antennae, a relay point, an access point, a serving node, a computing device (e.g., a server), just to name a few.

In some examples, the access management system 110 can determine that the message 104 includes battery data and optionally compare the battery data to a charge threshold. The charge threshold can, for example, represent a pre-determined value (or range of values) output by a model, component, and/or a user (e.g., an engineer). Based on the comparison between the charge level of the battery 114 to the charge threshold, the access management system 110 can select a first communication channel that does not limit a service or application and a second communication channel that limits or prevents the service or the application from operating at the device 106.

In various examples, the access management system 110 can, based at least in part on the battery data, send instructions to the network element to change a parameter, setting, etc. of the network element. In some examples, the change in parameter, setting, etc. can cause the network element to change power output, tilt angle, a number of carriers, and/or a number of layers, to name a few. In some examples, the instructions can be used to control operation of the network element to require lower power output by the device 106 (and therefore lower rate of discharge of the battery 114) to access the network element.

Output data from the access management system 110 can be used to optimize battery efficiency of the battery 114 coupled to the device 106. For example, the output data can indicate which communication channel to use at different times, and change communication channels over time dynamically in accordance with changes in the battery data. By dynamically changing communication channels over time as described herein, a communication session with the device 106 can transition between the multiple communication channels during the communication session to minimize or tailor power output for the battery charge level at different times. Accordingly, one or more communication channels may be used for a communication session between the device 106 and the network element (and optionally another device).

The storage device 112 can provide functionality to store and/or provide data associated with a network element or the device 106 usable for providing the techniques described herein. For example, the storage device 112 can receive, store, and/or provide battery data, historical data, predicted data, metadata, and/or profile data, to name a few. In some examples, the storage device 112 can provide battery charge level (or other battery data) to the access management system 110. The access management system 110 (or component thereof) may, for example, exchange data with the storage device 112 (e.g., a memory, a database, etc.) to implement the access techniques described herein.

In various examples, the storage device 112 can represent a Unified Data Management (UDM) to manage user data and/or an Authentication Server Function (AUSF) to manage authorization for the device 106 (e.g., in the 5G system shown). However, in examples when the core network 108 is different from 5G, such as 4G, the storage device 112 can represent a Home Subscriber Server (HSS). Thus, the storage device 112 can represent a subscription management entity depending upon a type of the core network 108 used to employ the techniques.

In some examples, the access management system 110 can determine metadata associated with the device 106 and/or the network element describing a charge level, applications or services, a time that the battery charged, and/or battery behavior over a previous and/or future time. In various examples, the access management system 110 can output metadata describing particular conditions (e.g., tilt angle, power output, distance data, timing parameter, weather conditions, time of day, etc.) associated with a network element that may optionally be correlated to the device metadata (e.g., charge levels). In various examples, the access management system 110 can determine a communication channel for the device 106 based at least in part on the metadata (e.g., network element metadata, device metadata, or a combination thereof).

In various examples, the access management system 110 can implement one or more models that may be representative of machine learned models, non-machine learning models, or a combination thereof. As described herein, a model may refer to a machine learning model that learns from a training data set to improve accuracy of an output (e.g., a prediction). Additionally or alternatively, a model may represent logic and/or mathematical functions that generate approximations which are usable to make predictions (e.g., a heuristic model, a statistical model, etc.).

In various examples, output data from the access management system 110 can be stored in the storage device 112 for access at a later time. For example, the storage device 112 can receive data representing previous output data by the access management system 110 for storage and make such data available to a component, device, etc. for processing at a later time (e.g., for analysis, training, etc.).

To implement the techniques described herein, in various examples the telecommunications system 102 and/or the access management system 110 can include one or more of: an a proxy call session control function (P-CSCF), an interrogating call session control function (ICSCF), a serving call session control function (SCSCF), a serving gateway (SGW), a packet data network gateway (PGW), a policy and charging rules function (PCRF), and an internet protocol short message gateway (IPSM-GW), a short message service center (SMSC), and an evolved packet data gateway (ePDG), and a Home Subscriber Server (HSS), just to name a few. In addition, the techniques described herein may be implemented using Real-Time Protocol (RTP) and/or Real-Time Control Protocol (RTCP), among others.

In various examples, the telecommunications system 102 (e.g., a 5G system) can represent functionality to provide a communication channel for the device 106 and can include one or more radio access networks (RANs), as well as one or more core networks linked to the RANs. For instance, the device 106 can represent a UE to wirelessly connect to a base station or other access point of a RAN, and in turn be connected to the core network (e.g., a 5G core network). The RANs and/or core networks can be compatible with one or more radio access technologies, wireless access technologies, protocols, and/or standards. For example, wireless and radio access technologies can include fifth generation (5G) technology, Long Term Evolution (LTE)/LTE Advanced technology, other fourth generation (4G) technology, third generation (3G) technology, High-Speed Data Packet Access (HSDPA)/Evolved High-Speed Packet Access (HSPA+) technology, Universal Mobile Telecommunications System (UMTS) technology, Global System for Mobile Communications (GSM) technology, WiFi technology, and/or any other previous or future generation of radio access technology. In this way, the telecommunications system 102 is compatible to operate with other radio technologies including those of other service providers. Accordingly, the message(s) 104 associated with the device 106 may originate with another service provider (e.g., a third-party) and be processed by the access management system 110 independent of the technolog(ies) or core network associated with the service provider.

In some examples, the access management system 110 can be included in or otherwise represent a computing device that receives battery information such as battery consumption or state-of-charge information from the device 106. The access management system 110 can, for example, receive the battery information in a message (e.g., the message 104) from the device 106 (e.g., sent periodically, in response to a request for battery information or consent to use the battery saving techniques, etc.). The RAN can wirelessly connect the device 106 to the core network(s) based on the battery information by considering the battery information when determining power control settings, a number of carriers, a number of layers, a type of service, a communication channel, a type of application, etc. for the device 106.

By way of example and not limitation, when the battery charge level is below a charge threshold (e.g., relatively low), the network element or other portion of the RAN, can prioritize battery saving communication channels that limit the number of uplink carriers and/or reduce the number of layers (e.g., multiple-input multiple-output layers (MIMO), etc.). By using a battery saving communication channel (relative to another available communication channel), the network element or RAN can ensure that only uplink carriers or layers that minimize or reduce power consumption by the battery 114 of the device 106 (e.g., reducing a corresponding amount of power required by the device to transmit at relatively higher power levels over multiple antennas or carriers). In examples when the battery charge level meets or exceeds the charge threshold, the access management system 110 can maximize throughput and efficiency by assigning more carriers or parts of carriers using bandwidth parts, MIMO layers, and/or power amplifiers to cause the device 106 to use more power to transmit data. The number of carriers and/or layers can, for example, cause the device 106 to consume different amounts of power from the battery, and may be associated with different communication channels.

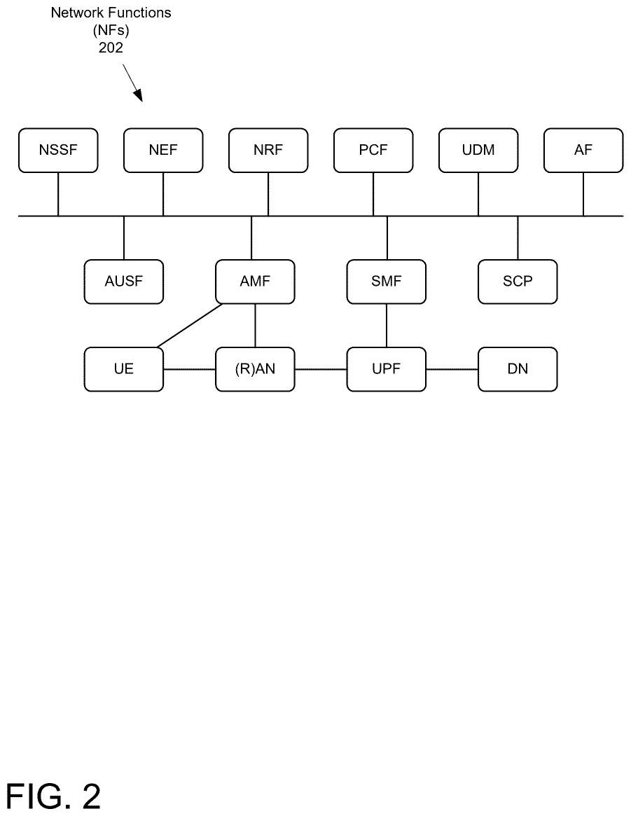

In some examples, the core network 108 can represent a service-based architecture that includes multiple types of network functions that process control plane data and/or user plane data to implement services for the device 106. In some examples, the services comprise rich communication services (RCS), a VoNR service, a ViNR service, and the like which may include a text, a data file transfer, an image, a video, or a combination thereof. The network functions of the core network 108 can include an Access and Mobility Management Function (AMF), a Session Management Function (SMF), a User Plane Function (UPF), a Policy Control Function (PCF), and/or other network functions implemented in software and/or hardware, just to name a few. Examples of network functions are also discussed in relation to FIG. 2, and elsewhere.

FIG. 2 depicts an example system architecture for a fifth generation (5G) telecommunication network. In some examples, the 5G telecommunication network can comprise the core network 108 in FIG. 1 that includes a service-based system architecture in which different types of network functions (NFs) 202 operate alone and/or together to implement services. Standards for 5G communications define many types of NFs 202 that can be present in 5G telecommunication networks (e.g., the 5G core network), including but not limited to an Authentication Server Function (AUSF), Access and Mobility Management Function (AMF), Data Network (DN), Unstructured Data Storage Function (UDSF), Network Exposure Function (NEF), Network Repository Function (NRF), Network Slice Selection Function (NSSF), Policy Control Function (PCF), Session Management Function (SMF), Unified Data Management (UDM), Unified Data Repository (UDR), User Plane Function (UPF), Application Function (AF), User Equipment (UE), (Radio) Access Network ((R)AN), 5G-Equipment Identity Register (5G-EIR), Network Data Analytics Function (NWDAF), Charging Function (CHF), Service Communication Proxy (SCP), Security Edge Protection Proxy (SEPP), Non-3GPP InterWorking Function (N3IWF), Trusted Non-3GPP Gateway Function (TNGF), and Wireline Access Gateway Function (W-AGF), many of which are shown in the example system architecture of FIG. 2.

One or more of the NFs 202 of the core network 108 can be implemented as network applications that execute within containers (not shown). The NFs 202 can execute as hardware elements, software elements, and/or combinations of the two within telecommunication network(s), and accordingly many types of the NFs 202 can be implemented as software and/or as virtualized functions that execute on cloud servers or other computing devices. Network applications that can execute within containers can also include any other type of network function, application, entity, module, element, or node.

The core network 108 can, in some examples, determine a connection between an IMS that manages a communication session for the device 106, including sessions for short messaging, voice calls, video calls, and/or other types of communications. For example, the device 106 and the IMS of the telecommunications system 102 can exchange Session Initiation Protocol (SIP) messages to set up and manage individual communication sessions. Different types of communications can, in some examples, utilize different communication channels which can be associated with different network element settings such as different power output by the network element and subsequently the device 106.

Though some examples in FIG. 1 and elsewhere are described in association with a 5G telecommunication system, the techniques described herein can be used in other telecommunication system types include past generation and/or future generation telecommunication systems.

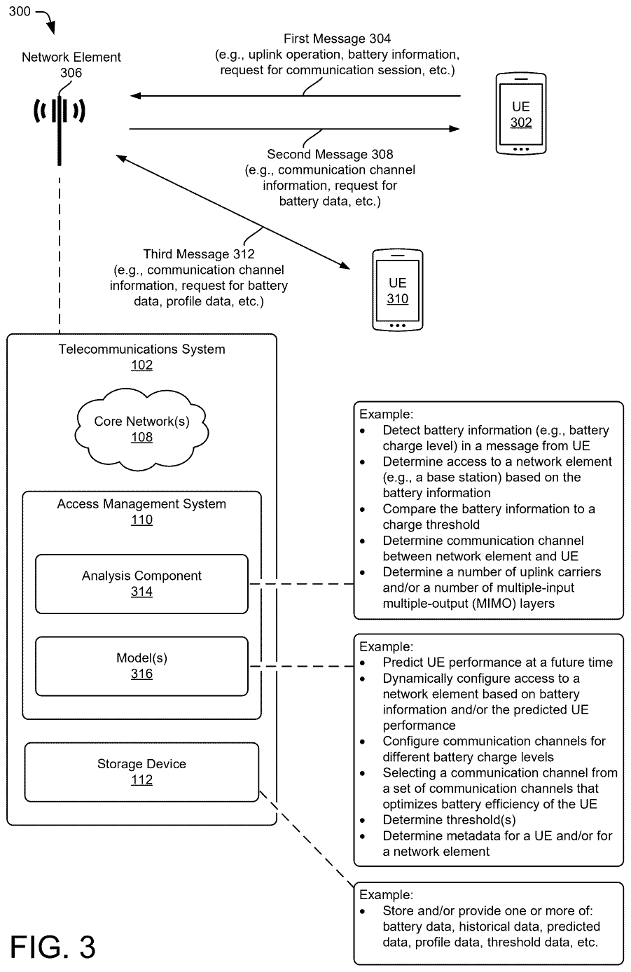

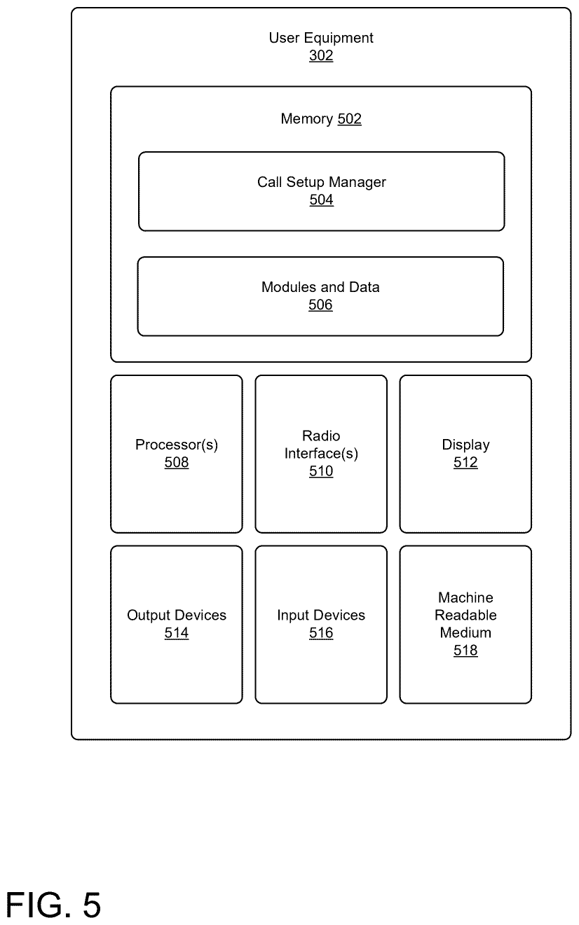

FIG. 3 depicts another example network environment 300 in which an example user equipment can connect to a telecommunication system that includes an example access management system to implement the techniques described herein. For example, a UE 302 can access the telecommunications system 102 of FIG. 1 by sending a first message 304 to a network element 306. The UE 302 may also or instead receive a second message 308 indicating communication channel to use for a communication session. In some examples, a UE 310 can exchange a third message 312 with the network element 306. An example architecture for the UE 302 is illustrated in greater detail in FIG. 5. The UE 302 can, in some examples, include at least the functionality of the device 106 of FIG. 1.

In various examples, the access management system 110 can operate (coupled to the network element 306 or remote from the network element 306) to process the first message 304 and determines a communication channel between the UE 302 and the network element 306 based on battery information detected in the first message 304 (or accessed from the storage device 112). The battery information in the first message 304 can indicate that the UE is using more power in a current time period than a previous time period (e.g., due to an application, an increase in transmission power due to a location of the UE 302 (e.g., in a tunnel, indoors, etc.), or the like.

In some examples, the first message 304 associated with UE 302 and/or the third message 312 associated with UE 310 can include battery information. For example, the first message 304 can be associated with an uplink operation or a request for a communication session (e.g., place a call, use an application, etc.) by the UE 302. In some examples, the first message 304 can be sent to the network element 306 to report battery information such as a charge level of the battery, change in charge level over time, etc. The access management system 110 can receive battery information periodically at pre-determined intervals (e.g., every two hours or some other interval).

In some examples, the access management system 110 can send the second message 308 to the UE 302 to request battery data. For instance, a message component (not shown) of the access management system 110 can configure the second message 308 for sending to the UE 302. The second message 308 may request that a user validate using the communication channel or otherwise saving battery charge, however, in other examples the UE 302 can respond to the second message 308 without requiring input from the user of the UE 302 (e.g., based on a previous authorization by the user to allow battery information to be shared). For example, the second message 308 may include a request for current and/or previous battery activity data, battery capacity for different times, etc. associated with the UE 302.

In some examples, the second message 308 can indicate a communication channel for a communication session based on the first message 304 including the battery data. In other examples, the second message 308 may include a request to perform an uplink operation and/or a request for a communication session, or the like, and the battery data can be accessed from the storage device 112. In some examples, the indication of the communication channel in the second message 308 can be in response to information included in the first message 304 (e.g., battery data, an uplink request, and/or a request to exchange data with another device). In some examples, the access management system 110 can send the second message 308 independent of receiving the first message 304 (e.g., to request for battery information from the UE).

In some examples, the third message 312 can represent a message from the UE 310 to the network element 306 that includes battery data associated with a battery of the UE 310 and/or profile data indicating preferences for whether to utilize battery saving techniques when connecting to a telecommunications network. The profile data can indicate which applications or services having priority to receive battery over another set of applications or services, which applications or services have access to the battery without implementing the battery saving techniques. The profile data may be associated with a previous time (e.g., historical activity by the UE), a current time (e.g., applications or services or other activity currently executed by the UE), or a future time (e.g., predicted activity by the UE over a future time period determined by the model(s) 316). In some examples, the third message 312 can include the access management system 110 accessing profile information, battery information, etc. indicating a preference associated with battery life relative to service quality, network efficiency, or the like.

In some examples, the network element 306 can represent a base station, a transceiver, or other element of the telecommunications network. In various examples, the network element 306 can represent an element of a radio access network. Additionally, or alternatively, the network element 306 can represent and/or include an Access and Mobility Management Function (AMF) or an IP Multimedia Subsystem (IMS) of the telecommunications system. In some examples, the AMF and/or the IMS can exchange information (e.g., energy efficient services and applications for a device) with the access management system 110 to implement the techniques described herein. In some examples, the AMF and/or the IMS can perform the functionality of the access management system 110.

FIG. 3 further depicts the access management system 110 comprising an analysis component 314 and one or more models 316 (also referred to herein as the model 316, or the model(s) 316) to implement the techniques described herein. The analysis component 314 can provide functionality to analyze input data including at least battery data and determine output data representing a configuration (e.g., a setting for the network element 306, a communication channel, etc.) for the UE 302 to exchange data with the network element 306. In various examples, the analysis component 314 can determine access to the network element 306 based on the battery data and other input data such as profile data, metadata, previous device activity, predicted device activity, and so on.

In some examples, the analysis component 314 can detect battery information (e.g., battery charge level) in the first message 304 from UE 302, and determine access to one or more network elements (e.g., the network element 306) based on the battery information. For example, the analysis component 314 can compare a charge level of the battery information to a charge threshold and determine a communication channel for use between the network element 306 and the UE 302 based on the charge level. In some examples, the communication channel can be associated with a charge range (e.g., 80% and above or some other value), and the communication channel (e.g., a first communication channel) can provide a set of services or applications based on the charge range. In examples when the charge level reaches a threshold value (e.g., 50%) then the analysis component 314 can determine another communication channel (a second communication channel) that is associated with a charge range of 46-55% and is configured to cause the UE 302 to use less power than another communication channel having a higher charge range (e.g., 56-64%).

In some examples, the analysis component 314 can determine a number of uplink carriers associated with an uplink operation and/or a number of MIMO layers for a new or existing communication session including the UE 302 or the UE 310. Over time, the analysis component 314 can determine whether to limit the number of uplink carriers or to determine whether to reduce the number of layers used to provide service to the UE 302 by dynamically assigning a communication channel for different portions of a communication session so that the UE uses a pre-determined number of carriers, input layers, or output layers to limit battery consumption by the UE at different times. By using the selected communication channel over time, the UE 302 can maintain a higher battery capacity for a greater length of time versus not implementing the selected communication channels. A battery of the UE 302 can last longer by reducing the power required for the UE 302 to use a corresponding communication channel.

In some examples, the analysis component 314 can output parameters or settings for the network element 306 to cause the UE 302 to receive service from the network element 306. For instance, the analysis component 314 can determine power output information for the network element 306 and transmit the power output information to the network element 306. The analysis component 314 may also or instead determine parameter settings to modify tilt angle, a frequency, and/or other characteristics of the network element 306.

Note that the first message 304, the second message 308, and the third message(s) 312 denote different instances of a message and do not reflect a temporal relationship unless otherwise noted. For example, one or more of the first message 304, the second message 308, and/or the third message(s) 312 may be excluded in some examples or otherwise received by the access management system 110 in any order relative to one another. Additionally or alternatively, the first message 304, the second message 308, and/or the third message(s) 312 may be exchanged with the access management system 110 at substantially simultaneously a same time.

By way of example and not limitation, the analysis component 314 can determine a battery charge level associated with the UE 302 and select a communication channel from a set of communication channels based at least in part on the battery charge level associated with the UE 302. For example, the battery charge level of the UE 302 may be considered by the analysis component 314 to select a communication channel for the UE 302 to use at a particular time.

In various examples, the model 316 may, for example, predict performance of the UE 302 at a future time (e.g., determine which applications, services, etc. will likely be used in the future, and a predicted power demand in the future). For instance, the model 316 can represent a machine learned model that is trained to predict future device performance and use the prediction to determine access for the UE 302 to the network element 306. For example, the machine learned model can predict a value representing an impact to battery capacity in the future (e.g., based on predicted future activity) and output the value for use as input data into the analysis component 314 that configures the network element to provide service to the UE 302. In this way, the analysis component 314 can consider a charge level of the battery (or other battery data) and a predicted impact to the battery in the future when determining the communication channel over time.

The model(s) 316 may also or instead determine metadata for the UE 302 (or battery thereof) and/or the network element 306 describing battery information and settings over a previous time period. In some examples, the metadata can represent battery data during previous activity associated with the UE (e.g., historical data). The historical data can represent battery charge at different times, times that the battery was charged, a rate of discharge, a rate of charge, etc.) and/or historical device activity data (e.g., services accessed, applications accessed, etc.). In some examples, the model(s) 316 can determine metadata representing predicted activity of the UE 302 based on the historical data, historical network element data, etc.

In some examples, the model(s) 316 can associate a communication channel with metadata to describe a battery charge level range, a minimum battery capacity, or the like for using the communication channel. For example, the model(s) 316 can determine a number of communication channels, the range of values (or other data) to associate with a communication channel, whether ranges overlap, and an optimal way to select a communication channel that may be associated with the ranges of two different communication channels and select the one closest to a median of a respective range of values.

In some examples, the model(s) 316 can determine threshold(s) such as a charge threshold, a battery discharge rate threshold, a battery charge rate threshold, etc. The analysis component 314 may compare a discharge rate of the UE 302 to a battery discharge rate threshold to determine whether to assign another communication channel that uses more or less power to affect the discharging of the UE 302 (e.g., to reduce discharging and improve battery storage).

Though the analysis component 314 and the one or more models 316 are illustrated in FIG. 3 individually, it is understood that the analysis component 314 and the one or more models 316 (or functionality provided therefrom) may be directly coupled to and/or integrated into a single component or computing device (including in some examples the UE 302). In some examples, functionality associated with the analysis component 314 and the one or more models 316 may be directly coupled to and/or integrated into the device 106 of FIG. 1 and/or the UE 302 of FIG. 3.

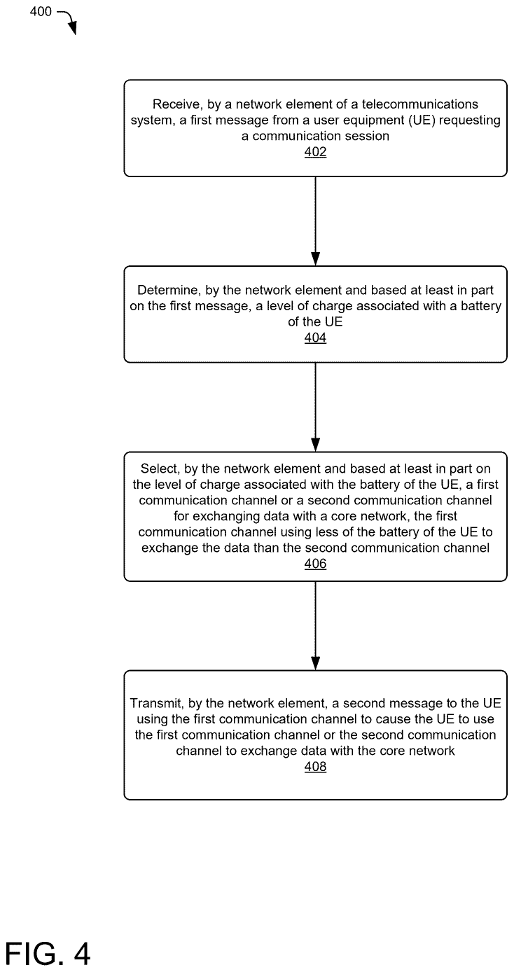

FIG. 4 depicts a flowchart of an example process 400 for selecting a communication channel for a user equipment by an example access management system based on detected battery data. Some or all of the process 400 may be performed by one or more components in FIGS. 1-3, as described herein. For example, some or all of process 400 may be performed by the access management system 110 of FIG. 1. In some examples, a communication channel can be determined for a UE to modify an amount of power output by the UE.

At operation 402, the process may include receiving, by a network element of a telecommunications system, a first message from a user equipment (UE) requesting a communication session. For example, the network element 306 can receive a first message 304 from the UE 302 using a core network (e.g., the core network(s) 108). In some examples, the operation 402 may include the access management system 110 receiving message data from the device 106 to exchange data (e.g., request a communication session with another UE, maintain an existing communication session, etc.). The access management system 110 may, for instance, receive a message (e.g., the message 104) from the device 106 to establish or maintain a voice, video, and/or text communication session.

In some examples, the network element can represent a base station for providing service to the UE 302. The message from the UE 302 can, for example, include battery data, profile data, historical data, or other characteristics of the UE 302 usable for determining a communication channel.

At operation 404, the process may include determining, by the network element and based at least in part on the first message, a level of charge associated with a battery of the UE. For instance, the access management system 110 can identify, detect, or otherwise determine the level of charge associated with a battery of the UE 302 in the battery data. In examples when the UE 302 changes position over time, the access management system 110 can analyze new messages exchanged with the UE 302 to detect new battery data associated with one or more messages at different times.

At operation 406, the process may include selecting, by the network element and based at least in part on the level of charge associated with the battery of the UE, a first communication channel or a second communication channel for exchanging data with a core network. In some examples, the operation 406 may include the access management system 110 identifying that the first communication channel can cause to the UE 302 to use less power from the battery of the UE to exchange first data than an amount of power needed to exchange second data using the second communication channel. The access management system 110 can, for example, select a communication channel for use by the UE 302 based on mapping a charge range associated with different communication channels to a charge level of the battery. For example, access management system 110 can configure the first communication channel for a first battery charge range and the second communication channel for a second battery charge range and match the level of charge of the battery to one of: the first battery charge range or the second battery charge range.

In some examples, the operation 406 may include the access management system 110 selecting the first communication channel or the second communication channel based at least in part on analyzing metadata associated with respective communication channels. The communication channels may be associated with respective metadata for use in identifying characteristics of each communication channel (e.g., desired battery level, discharge rate, etc.). In some examples, the access management system 110 can implement the model(s) 316 to determine predicted battery activity for further considering during selection of a communication channel.

In some examples, the operation 406 may include the access management system 110 determining that the level of charge of the battery meets or exceeds a charge threshold, and selecting the first communication channel relative to the second communication channel based at least in part on the level of charge of the battery meeting or exceeding the charge threshold. For example, if the battery of the UE is sufficiently charged then the access management system 110 may select the second communication channel to enable or cause the battery to provide more power for use by the UE.

At operation 408, the process may include transmitting, by the network element, a second message to the UE using the first communication channel to cause the UE to use the first communication channel or the second communication channel as selected to exchange data with the core network. In some examples, the operation 408 may include the access management system 110 (e.g., at a network element or other location) transmitting the second message 308 to the UE 302 to cause the UE 302 to use the selected communication channel. In some examples a same or different instruction output by the access management system 110 can include one or more settings or parameters for modifying a mechanical tilt angle, an electronic tilt angle, power output, frequency, or the like of the network element 306. Directing the UE to use the first communication channel to transmit data instead of the second communication channel may cause the UE to save an amount of charge of the battery. For example, the access management system 110 can cause the UE 302 to reduce battery consumption by using the first communication channel that enables fewer carriers, layers, functions within one or more layers, or other characteristics thereby saving power stored in the battery that would have been used with the second communication channel due to the second communication channel enabling more services, applications, carriers, layers, functions within one or more layers, etc.

In various examples, the layers can represent MIMO layers and the access management system 110 can associate the first communication channel and the second communication channel with a different layers for use at different times. For example, the layers (and associated communication channel) can be used by the UE 302 during an uplink operation and/or a downlink operation. In some examples, the access management system 110 can select the second communication channel for the UE 302 to cause the UE 302 to send and/or receive fewer transmissions (e.g., to save current draw at the UE). In some examples, the access management system 110 can change a number of MIMO layers available to the UE 302 by selecting a communication channel over time to cause the UE 302 to “sleep” between data transmissions for a period of time (to save computational resources at the UE). By way of example and not limitation, the access management system 110 can communicate with the UE 302 using a media access control (MAC) protocol layer.

FIG. 5 depicts an example system architecture for the UE 302, in accordance with various examples. As shown, a UE 302 can have memory 502 storing a call setup manager 504, and other modules and data 506. A UE 302 can also comprise processor(s) 508, radio interfaces 510, a display 512, output devices 514, input devices 516, and/or a machine readable medium 518.

In various examples, the memory 502 can include system memory, which may be volatile (such as RAM), non-volatile (such as ROM, flash memory, etc.) or some combination of the two. The memory 502 can further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store desired information and which can be accessed by the UE 302. Any such non-transitory computer-readable media may be part of the UE 302.

The call setup manager 504 can send and/or receive messages comprising a VoNR service, a ViNR service, and/or an RCS service including SIP messages associated with setup and management of a call session via an IMS, an AMF, or the like. The SIP messages can include an SIP INVITE message and/or other SIP messages.

The other modules and data 506 can be utilized by the UE 302 to perform or enable performing any action taken by the UE 302. The modules and data 506 can include a UE platform, operating system, and applications, and data utilized by the platform, operating system, and applications.

In various examples, the processor(s) 508 can be a central processing unit (CPU), a graphics processing unit (GPU), or both CPU and GPU, or any other type of processing unit. Each of the one or more processor(s) 508 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 508 may also be responsible for executing all computer applications stored in the memory 502, which can be associated with common types of volatile (RAM) and/or nonvolatile (ROM) memory.

The radio interfaces 510 can include transceivers, modems, interfaces, antennas, and/or other components that perform or assist in exchanging radio frequency (RF) communications with base stations of the telecommunication network, a Wi-Fi access point, and/or otherwise implement connections with one or more networks. For example, the radio interfaces 510 can be compatible with multiple radio access technologies, such as 5G radio access technologies and 4G/LTE radio access technologies. Accordingly, the radio interfaces 510 can allow the UE 302 to connect to a 5G system and/or a 4G system (or other past or future system) as described herein.

The display 512 can be a liquid crystal display or any other type of display commonly used in UEs. For example, display 512 may be a touch-sensitive display screen, and can then also act as an input device or keypad, such as for providing a soft-key keyboard, navigation buttons, or any other type of interactive input. In some examples, the display 512 can represent a wearable device such as a headset for presenting and/or receiving data associated with a user. The output devices 514 can include any sort of output devices known in the art, such as the display 512, speakers, a vibrating mechanism, and/or a tactile feedback mechanism. Output devices 514 can also include ports for one or more peripheral devices, such as headphones, peripheral speakers, and/or a peripheral display. The input devices 516 can include any sort of input devices known in the art. For example, input devices 516 can include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

The machine readable medium 518 can store one or more sets of instructions, such as software or firmware, that embodies any one or more of the methodologies or functions described herein. The instructions can also reside, completely or at least partially, within the memory 502, processor(s) 508, and/or radio interface(s) 510 during execution thereof by the UE 302. The memory 502 and the processor(s) 508 also can constitute machine readable media 518.

The various techniques described herein may be implemented in the context of computer-executable instructions or software, such as program modules, that are stored in computer-readable storage and executed by the processor(s) of one or more computing devices such as those illustrated in the figures. Generally, program modules include routines, programs, objects, components, data structures, etc., and define operating logic for performing particular tasks or implement particular abstract data types.

Other architectures may be used to implement the described functionality and are intended to be within the scope of this disclosure. Furthermore, although specific distributions of responsibilities are defined above for purposes of discussion, the various functions and responsibilities might be distributed and divided in different ways, depending on circumstances.

Similarly, software may be stored and distributed in various ways and using different means, and the particular software storage and execution configurations described above may be varied in many different ways. Thus, software implementing the techniques described above may be distributed on various types of computer-readable media, not limited to the forms of memory that are specifically described.

### Conclusion

Although the subject matter has been described in language specific to structural features and/or methodological acts, it is to be understood that the subject matter is not necessarily limited to the specific features or acts described above. Rather, the specific features and acts described above are disclosed as example embodiments.

While one or more examples of the techniques described herein have been described, various alterations, additions, permutations and equivalents thereof are included within the scope of the techniques described herein.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein can be presented in a certain order, in some cases the ordering can be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

What is claimed is:

1. A method comprising:
receiving, by a network element of a telecommunications system, a first message from a user equipment (UE) requesting a communication session;
determining, by the network element and based at least in part on the first message, a level of charge associated with a battery of the UE;
selecting, by the network element and based at least in part on the level of charge associated with the battery of the UE, a first communication channel or a second communication channel for exchanging data with a core network, the first communication channel using less of the battery of the UE to exchange the data than the second communication channel; and
transmitting, by the network element, a second message to the UE using the first communication channel to cause the UE to use the first communication channel or the second communication channel to exchange data with the core network,
wherein causing the UE to use the first communication channel saves an amount of charge of the battery relative to using the second communication channel.

2. The method of claim 1, further comprising:
determining metadata associated with the UE based at least in part on previous battery activity of the battery or predicted battery activity of the battery,
wherein selecting the first communication channel or the second communication channel is further based at least in part on the metadata.

3. The method of claim 1, wherein:
the network element comprises a base station, and
determining that the level of charge of the battery is based at least in part on the UE sending battery charge data as part of an uplink operation by the telecommunications system.

4. The method of claim 1, further comprising:
determining that the level of charge of the battery meets or exceeds a charge threshold,
wherein selecting the first communication channel or the second communication channel is based at least in part on the level of charge of the battery meeting or exceeding the charge threshold.

5. The method of claim 1, further comprising:
determining that the level of charge of the battery is below a charge threshold; and
outputting, based at least in part on the level of charge of the battery is below the charge threshold, a third message to the UE indicating an option to use a service or save a battery charge level,
wherein selecting the first communication channel or the second communication channel is further based at least in part on a response to the third message.

6. The method of claim 1, further comprising:
accessing profile information for the UE indicating a preference for battery life or service quality; and
selecting the first communication channel based at least in part on the profile information.

7. A system comprising:
one or more processors; and
memory storing computer-executable instructions that, when executed by the one or more processors, cause the system to perform operations comprising:
receiving, by a network element of a telecommunications system, a first message from a user equipment (UE) requesting a communication session;
determining, by the network element and based at least in part on the first message, a level of charge associated with a battery of the UE;
selecting, by the network element and based at least in part on the level of charge associated with the battery of the UE, a first communication channel or a second communication channel for exchanging data with a core network, the first communication channel using less of the battery of the UE to exchange the data than the second communication channel; and
transmitting, by the network element, a second message to the UE indicating the first communication channel to cause the UE to use the first communication channel or the second communication channel to exchange data with the core network,
wherein causing the UE to use the first communication channel saves an amount of charge of the battery relative to using the second communication channel.

8. The system of claim 7, the operations further comprising:
determining metadata associated with the UE based at least in part on previous battery activity of the battery or predicted battery activity of the battery,
wherein selecting the first communication channel or the second communication channel is further based at least in part on the metadata.

9. The system of claim 7, wherein:
the network element comprises a base station, and
determining that the level of charge of the battery is based at least in part on the UE sending battery charge data as part of an uplink operation by the telecommunications system.

10. The system of claim 7, the operations further comprising:
determining that the level of charge of the battery meets or exceeds a charge threshold,
wherein selecting the first communication channel or the second communication channel is based at least in part on the level of charge of the battery meeting or exceeding the charge threshold.

11. The system of claim 7, the operations further comprising:
determining that the level of charge of the battery is below a charge threshold;
outputting, based at least in part on the level of charge of the battery is below the charge threshold, a third message to the UE indicating an option to use a service or save a battery charge level,
wherein selecting the first communication channel or the second communication channel is further based at least in part on a response to the third message.

12. The system of claim 7, the operations further comprising:
accessing profile information for the UE indicating a preference associated with battery life or service quality,
wherein selecting the first communication channel or the second communication channel is further based at least in part on the profile information.

13. The system of claim 7, the operations further comprising:
sending instructions to the UE to cause the UE to transmit a current charge level of the battery.

14. The system of claim 7, the operations further comprising:
configuring the first communication channel for a first battery charge range and the second communication channel for a second battery charge range; and
matching the level of charge of the battery to one of: the first battery charge range or the second battery charge range.

15. The system of claim 7, the operations further comprising:
causing the UE to exchange the data with the core network using the first communication channel.

16. One or more non-transitory computer-readable media storing instructions executable by one or more processors, wherein the instructions, when executed, cause the one or more processors to perform operations comprising:
receiving, by a network element of a telecommunications system, a first message from a user equipment (UE) requesting a communication session;
determining, by the network element and based at least in part on the first message, a level of charge associated with a battery of the UE;
selecting, by the network element and based at least in part on the level of charge associated with the battery of the UE, a first communication channel or a second communication channel for exchanging data with a core network, the first communication channel using less of the battery of the UE to exchange the data than the second communication channel; and
transmitting, by the network element, a second message to the UE indicating the first communication channel to cause the UE to use the first communication channel or the second communication channel to exchange data with the core network,
wherein causing the UE to save an amount of charge of the battery using the first communication channel to transmit the data relative to using the second communication channel.

17. The one or more non-transitory computer-readable media of claim 16, the operations further comprising:
determining metadata associated with the UE based at least in part on previous battery activity of the battery or predicted battery activity of the battery,
wherein selecting the first communication channel or the second communication channel is further based at least in part on the metadata.

18. The one or more non-transitory computer-readable media of claim 16, wherein:
the network element comprises a base station, and
determining that the level of charge of the battery is based at least in part on the UE sending battery charge data as part of an uplink operation by the telecommunications system.

19. The one or more non-transitory computer-readable media of claim 16, the operations further comprising:
determining that the level of charge of the battery meets or exceeds a charge threshold,
wherein selecting the first communication channel or the second communication channel is based at least in part on the level of charge of the battery meeting or exceeding the charge threshold.

20. The one or more non-transitory computer-readable media of claim 16, the operations further comprising:
determining that the level of charge of the battery is below a charge threshold; and
outputting, based at least in part on the level of charge of the battery is below the charge threshold, a third message to the UE indicating an option to use a service or save a battery charge level,
wherein selecting the first communication channel or the second communication channel is further based at least in part on a response to the third message.
